(19) United States
(12) Patent Application Publication
(10) Pub. No.: US 2004/0087346 A1
(43) Pub. Date: May 6, 2004

(54) Mobile handset and assembly having multi-loudspeaker system

(76) Inventors: Leif Johannsen, Odder (DK); Morten Kjeldsen Andersen, Odder (DK)

Correspondence Address: HARNESS, DICKEY & PIERCE, P.L.C., P.O. BOX 8910, RESTON, VA, 20195, US

(21) Appl. No.: 10/621,325

(22) Filed: Jul. 18, 2003

Related U.S. Application Data
(60) Provisional application No. 60/398,117, filed on Jul. 25, 2002.
(60) Provisional application No. 60/411,099, filed on Sep. 17, 2002.

(51) Int. Cl. H04M 1/00; H04B 1/38

(52) U.S. Cl. 455/566; 455/575.1

(57) ABSTRACT

The present invention relates to a mobile handset comprising a handset housing comprising a front and a back cover, display means being visible from the front cover side of the handset housing, the display means being adapted to provide visual information to a user of the mobile handset. The mobile handset further comprises a plurality of loudspeakers being adapted to generate audio signals, wherein each of the plurality of loudspeakers comprises a magnetic circuit comprising a magnet, the magnetic circuit having at least one gap defined between two opposed and substantially parallel surfaces of the magnetic circuit. The magnet of the magnetic circuit causes a magnetic field to exist across the at least one gap. The magnetic circuit is so arranged that it defines magnetic return paths completely encircling the gap.

### FIELD OF THE INVENTION

The present invention relates to mobile handsets having a multi-loudspeaker system. In particular, the present invention relates to mobile handsets having a LCOS display suitable for near-to-the eye applications, and a multi-loudspeaker system.

### BACKGROUND OF THE INVENTION

Today, mobile handsets, such as mobile telephones, PDAs or the like, are equipped with only a single loudspeaker for providing an audio signal in mono only. Stereo reproduction has not been an important issue since the loudspeaker of e.g. a mobile phone has been positioned close the listener's ear.

With the recent developments within the telecommunication industry there is a need for mobile handsets being capable of providing high quality audio signals. The latest near-to-the-eye displays for mobile equipment provide high quality colour pictures with adequate resolution to enable new possibilities, such as watching movies using a mobile phone when held at a distance of 5-10 cm from the user's eye—the so-called near-to-eye application. Such new use of mobile equipment makes new demands on the sound reproduction system for providing sound of equal quality in order to support the new applications made possible with the latest display technique. New sound reproduction systems should at least support normal two channel stereo sound. More preferably, such new systems should be prepared for providing true 3 dimensional (3D) sound.

Portable computers have for a number of years been equipped with more than one loudspeaker so as to be able to support stereo, or multi-channel, audio reproduction. Such a portable computer with two loudspeakers is disclosed in JP 08307981.

However, the demands regarding small dimensions are very strict in order to provide a mobile phone with more than one loudspeaker capable of producing high quality acoustical output at a certain distance from a person's ears without increasing dimensions of the mobile phone.

However, it is not possible to directly transfer the loudspeaker technology known from portable computers to e.g. mobile phones, since these known loudspeakers require too much space which would result in a increase of the dimensions of e.g. mobile phones.

EP 1 124 175 A2 relates to a display apparatus including a display and an orientation sensitive interface mechanism. The orientation sensitive interface includes first and second loudspeaker pairs. The first loudspeaker pair includes first and second loudspeakers and the second loudspeaker pair includes the second and third loudspeaker. The first and second loudspeaker pairs are disposed along transverse directions to each other. The display apparatus comprises a switch which switches between the first loudspeaker pair and the second loudspeaker pair. By providing the respective loudspeaker pairs, and switching between them, it is possible to orient the display apparatus in transverse directions corresponding to respective loudspeaker pairs, yet maintain a substantially stereophonic reproduction for each orientation.

It is a disadvantage of the display apparatus of EP 1 124 175 A2 that it utilises conventional loudspeakers. In order for such loudspeakers to fit into a display apparatus, the apparatus must have a certain height in order for it to be able to house such conventional loudspeakers.

It is an object of the present invention to provide a slim mobile handset with integrated display and audio system suitable for near-to-the-eye applications.

It is a further object of the present invention to provide a slim integrated display and audio assembly suitable for near-to-the-eye applications in mobile handsets.

### SUMMARY OF THE INVENTION

The above-mentioned object are complied with by providing, in a first aspect, a mobile handset comprising

a handset housing comprising a front and a back cover,

display means being visible from the front cover side of the handset housing, the display means being adapted to provide visual information to a user of the mobile handset, and

a plurality of loudspeakers being adapted to generate audio signals, wherein each of the plurality of loudspeakers comprises a magnetic circuit comprising a magnet, the magnetic circuit having at least one gap defined between two opposed and substantially parallel surfaces of the magnetic circuit, the magnet of the magnetic circuit causes a magnetic field to exist across the at least one gap,

wherein the magnetic circuit defines magnetic return paths completely encircling the gap.

Preferably, the mobile handset further comprises image compensation means so as to allow the mobile handset to be applied in near-to-the-eye applications.

In a second aspect, the present invention relates to a mobile handset comprising

a handset housing comprising a front and a back cover,

a plurality of loudspeakers being adapted to generate audio signals,

display means being visible from the front cover side of the handset housing, the display means being adapted to provide visual information to a user of the mobile handset, and

image compensation means so as to allow the mobile handset to be applied in near-to-the-eye applications.

In this second aspect, each of the plurality of loudspeakers comprises a magnetic circuit comprising a magnet, the magnetic circuit having at least one gap defined between two opposed and substantially parallel surfaces of the magnetic circuit, the magnet of the magnetic circuit causes a magnetic field to exist across the at least one gap, and wherein the magnetic circuit defines magnetic return paths completely encircling the gap.

The mobile handset may in principle be any kind of mobile handset. Particular interesting mobile handsets may be mobile phones, PDAs, or portable game devices. Preferable, the display means may be a colour display, such as a LCOS display, suitable for near-to-eye applications.

The plurality of loudspeakers may be arranged within the handset housing so that the audio signals are transmitted from the front cover side of the handset housing.

In one embodiment, two loudspeakers are arranged at two opposing sides of the display means. In another embodiment, a third speaker is positioned between the two oppositely arranged loudspeakers and at a third side of the display means. The plurality of loudspeakers may comprise a number of loudspeaker units, each loudspeaker unit comprising at least one movable diaphragm. The loudspeakers may be arranged so as to emit sound from e.g. the front cover of the mobile handset. Alternatively or in addition, loudspeakers may be arranged so as to transmit sound from a side of the mobile handset. This may be achieved by providing loudspeakers having front covers each defining a mean/average plane, where the sound is transmitted from the loudspeaker in a direction being substantially parallel with the mean/average plane defined by the front cover.

The mobile handset may further comprise means for controlling a pointer shown on the display means. The control means may comprise a navigation key accessible from the back cover side of the handset housing, the navigation key being capable of providing two-dimensional control of the pointer on the display means. The navigation key may be capable of selecting information displayed on the display means upon moving the navigation key from an initial position to a select position by applying a pressure to the navigation key in a direction towards the back cover of the handset housing.

The mobile handset may further comprise vibration means so as to vibrate the mobile handset in accordance with a vibration signal provided to the vibration means.

In a third aspect, the present invention relates to a display and audio assembly for mobile handsets, the display and audio assembly comprising

display means adapted to provide visual information,

a plurality of loudspeakers being adapted to generate audio signals, wherein each of the plurality of loudspeakers comprises a magnetic circuit comprising a magnet, the magnetic circuit having at least one gap defined between two opposed and substantially parallel surfaces of the magnetic circuit, the magnet of the magnetic circuit causes a magnetic field to exist across the at least one gap,

wherein the magnetic circuit defines magnetic return paths completely encircling the gap.

Again, the display means may be a colour display, such as a LCOS display, preferably suitable for near-to-eye applications. For this purpose, the mobile handset, or the display itself, further comprises image compensation means so as to allow for the mobile handset to be applied in connection with near-to-the-eye applications.

In one embodiment of the assembly, two loudspeakers may be arranged at two opposing sides of the display means. In a second embodiment of the invention, a third speaker may be positioned between the two oppositely arranged loudspeakers and at a third side of the display means. Each of the plurality of loudspeakers may comprise a number of loudspeaker units, each loudspeaker unit comprising at least one movable diaphragm.

The assembly may further comprise means for controlling a pointer shown on the display means. The control means may, as in the first aspect, comprise a navigation key, the navigation key being capable of providing two-dimensional control of the pointer on the display means. The navigation key may be capable of selecting information displayed on the display means upon moving the navigation key from an initial position to a select position by applying a pressure to the navigation key in a certain direction and with a certain force.

The mobile handset and the assembly may further comprise a number of drivers for driving the loudspeakers. This could be one or more drivers for each loudspeaker. Preferably, at least a number of the drivers are class D drivers. In addition, both the assembly and the mobile handset may further comprise an electronic decoding circuit for decoding a received digital signal into two or more driver signals, each driver signal being provided to a loudspeaker via at least one driver.

### BRIEF DESCRIPTION OF THE DRAWINGS

In the following, the present invention will be explained in further details with reference to the accompanying figures, where

FIG. 1 shows a mobile telephone comprising a display and two loudspeaker arranged in opposite sides of the display,

FIG. 2 shows a mobile telephone comprising a display and three loudspeaker, two of the loudspeakers being arranged on opposite sides of the display, the third speaker being position between the oppositely arranged loudspeakers and below the display,

FIG. 3 shows a mobile telephone comprising a display and three loudspeaker, two of the loudspeakers being arranged on opposite sides of the display and transmitting sound through holes in the side walls of the mobile telephone, the third speaker being position between the oppositely arranged loudspeakers and below the display,

FIG. 4 shows a navigation key positioned on the back side of a mobile telephone,

FIG. 5 shows a DPA comprising a display and two loudspeaker arranged in opposite sides of the display,

FIG. 6 is a perspective view showing a suitable loudspeaker with its essential parts exploded seen from above,

FIG. 7 shows the same parts in perspective seen from below,

FIG. 8 shows the magnetic circuit of the transducer in FIGS. 6 and 7,

FIG. 9 is a perspective view showing a one-magnet loudspeaker with its essential parts exploded seen from above,

FIG. 10 shows the same parts (as FIG. 9) in perspective seen from below,

FIG. 11 is a perspective view showing another suitable loudspeaker with its essential parts exploded seen from above,

FIGS. 12a and 12b show a loudspeaker where sound is transmitted in a direction substantially parallel to the direction of movements of the diaphragm, and

FIGS. 13a and 13b shows a loudspeaker where sound is transmitted in a direction substantially perpendicular to the direction of movements of the diaphragm.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE INVENTION

The present invention will now be described with reference to particular embodiments. However, those skilled in the art will recognise that many changes may be made thereto without departing from the spirit and scope of the present invention.

In general, the present invention may be adapted to mobile phones where it is possible to achieve e.g. stereo sound.

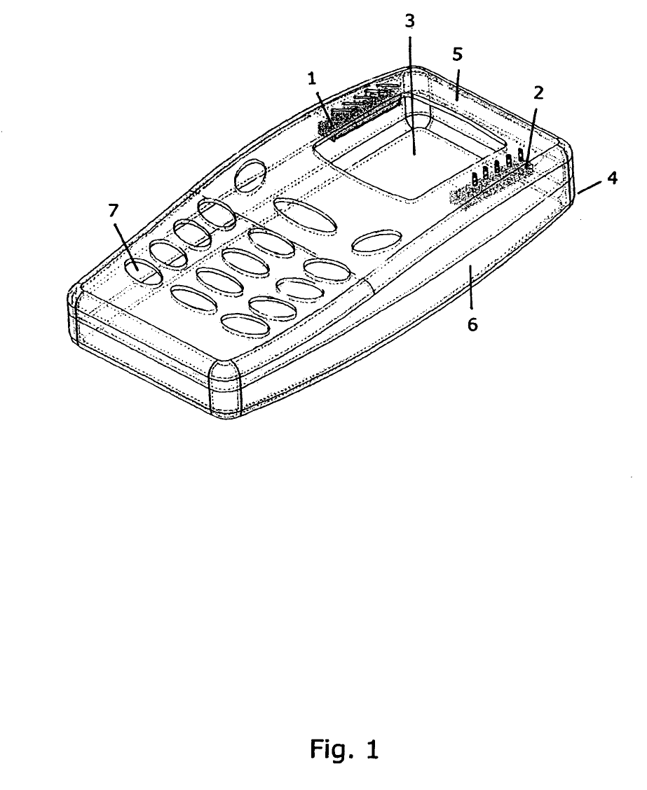

Now referring to FIG. 1, the present invention is shown in its simple form where two loudspeakers 1,2 are oppositely arranged relative to a display 3 in a mobile telephone 4. Each loudspeaker may be a combination of a plurality of loudspeakers. In FIG. 1, the loudspeakers 1,2 are shown as being positioned in the front cover 5 of the mobile telephone 4, but they may, alternatively or in addition, be placed in the two opposite side wall sections 6 of the mobile telephone.

Preferably, the display 3 positioned between two loudspeaker 1,2 is a display suitable for near-to-the-eye applications so that e.g. an Internet Web Side may by shown on the display with a resolution which to the user of the display corresponds to a resolution of a standard 17 or 19 inch monitor. In combination with the two loudspeakers 1,2, the near-to-the-eye display is suitable for showing e.g. videos/movies with stereo soundtracks being played via the two loudspeakers 1,2. Electronic manipulation, such as phase manipulation, may be applied to enhance the achievable stereo effect in spite of the small distance between the two loudspeakers 1,2.

The keys 7 shown in the bottom part of the mobile telephone are the standard keys of conventional mobile telephones. These standard keys may be supplemented with a rotating navigation key e.g. positioned between the display and the standard keys.

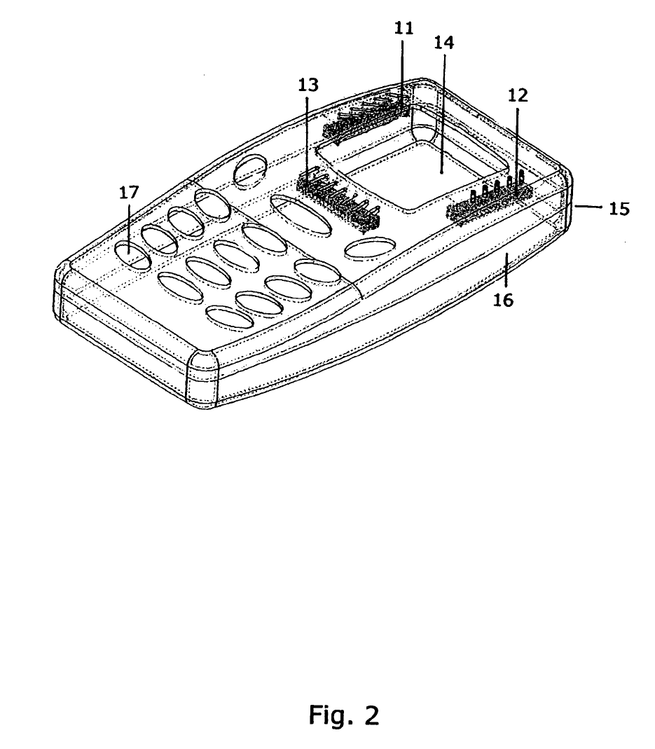

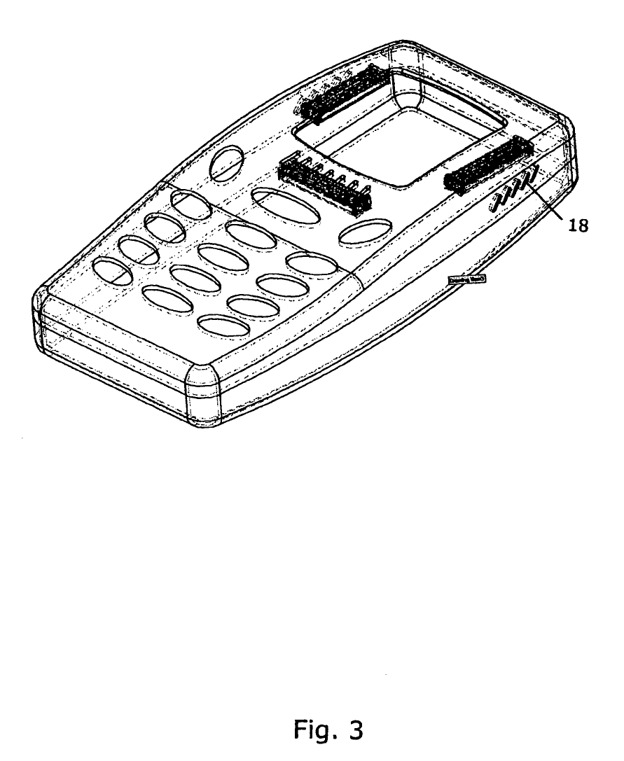

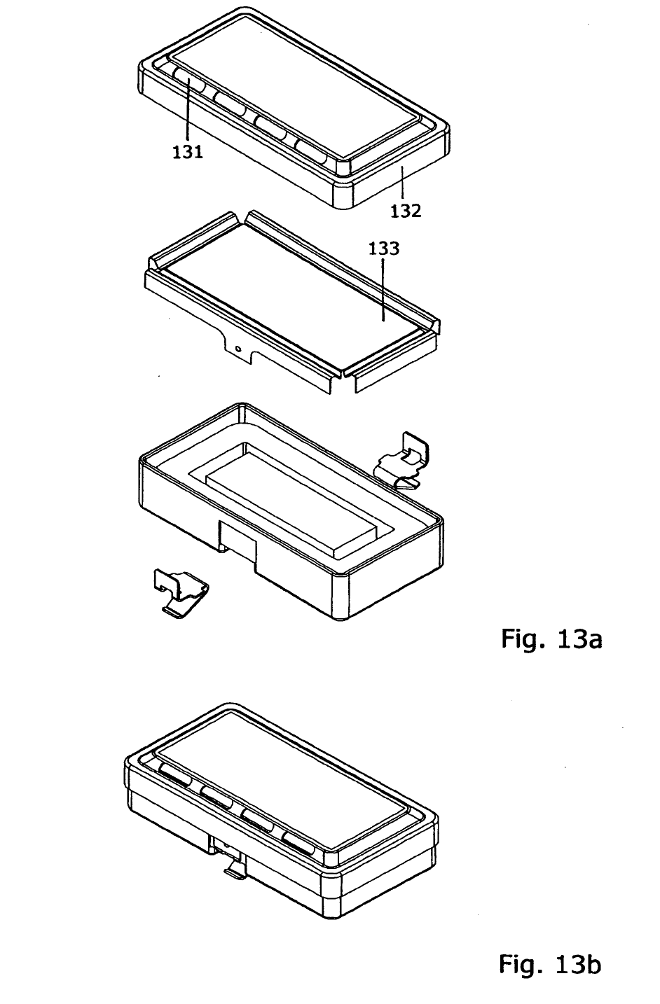

In FIG. 2 another embodiment of the present invention is shown in which two loudspeakers 11,12 are oppositely arranged relative to a display 14 in a mobile telephone 15, and where a third loudspeaker 13 is positioned below the display 14—for example between the display 14 and the key pads 17. Again, each loudspeaker may be a combination of several loudspeakers. Also in this embodiment, the loudspeakers oppositely arranged relative to the display may, alternatively or in addition, be configured so as to transmit sound through the two opposite side wall sections 16 of the mobile telephone—see FIG. 3. The transmitting of sound through holes 18 (in FIG. 3) in the side walls of the mobile telephone may be provided without changing the orientation of the loudspeaker itself. Instead a special designed front cover is positioned above the diaphragm—see FIG. 13. This front cover directs the sound in a direction being substantially perpendicular to the movements of the diaphragm. Obviously, side wall transmitting loudspeakers are also applicable in connection with other handheld devices, such as for example PDAs.

In any of the embodiments shown in FIG. 1 or 2, the mobile phone will, preferably, comprise an electronic circuit for receiving a single signal, such as a television signal, a GSM signal etc., and for decoding this signal into two or more audio signal which are provided to the loudspeakers via loudspeaker drivers whereby stereo like effects are achievable. Each loudspeaker could be driven by one or more loudspeaker drivers that could be class D drivers. However, it is to be understood that other types/classes of drivers could be applied as well, such as class A, B or A/B drivers.

The above-mentioned electronic decoding circuitry may be combined with filters so that a certain frequency range may be provided to the given loudspeaker or group of loudspeakers. At the same time a different frequency range may be provided to a different loudspeaker or different group of loudspeakers. In the way, sub-woofer like systems may be obtained whereby also surround-like effects are achievable.

The advantage of including a single-input decoder in mobile phones is related to the fact such decoder only requires a single input terminal for receiving the signal to be decoded.

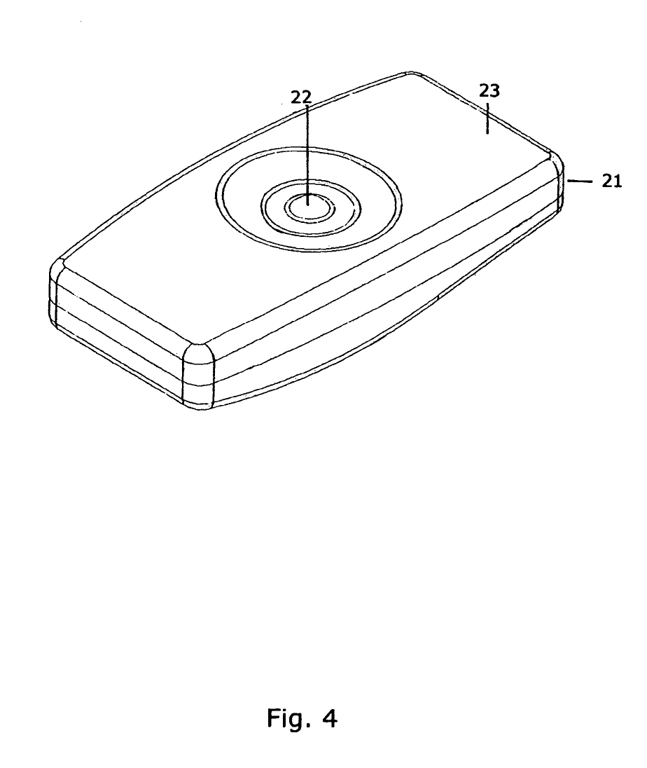

FIG. 4 shows a mobile phone with a navigation key 22—in this situation a so-called roller key—positioned on the back-side 23 of the housing of the mobile phone 21. In principle, the roller key may take any form, such as spherical (as shown in FIG. 4) or cylindrical with varying or constant diameter etc.

In case of a cylindrical roller key, such roller key could comprise a plastic moulded roller member which is rotatably mounted in a carrier, which is displaceably mounted in a supporting frame. In principle, the moulded roller member may take any form. The centre section of the roller member may have a smaller diameter than the end sections of the roller member. Means for detecting the rotation of the roller member is connected to the roller member. A detent spring element is also mounted on the frame and returns the roller member to a relaxed position when it is vertically depressed. The mounting is so that when applying a force to the roller member at either end and perpendicular to the axis of the roller member, the same end of the roller member will be displaced leaving the opposite end of the roller member in its relaxed position. Applying a force to the centre of the roller member and perpendicular to the axis of the roller member will displace the entire roller member.

In order to detect the displacements, two actuator contacts are positioned below the roller member and depressing corresponding parts of the roller member activate either one or both contacts.

The roller key may in excess of the navigation possibilities in rolling or scrolling, provides switch signal outputs corresponding to at least four different logic states. This is achieved by having at least two actuator contacts, which can be depressed individually or simultaneously by depressing corresponding parts of the roller member. In case of a spherical roller key, the device housing the spherical roller key may comprise means for biasing the position of the roller key towards an initial position. This means for biasing is preferably constituted by a spring for spring biasing the position of the spherical roller key towards the initial position.

The roller key is preferably arranged over the housing of the device so that the roller key and housing defines a ball-and-socket joint connection with the housing inside the control knob. The extent of movement of the roller key thus being limited by the housing. Preferably, the extent of movement of the roller key from the initial position to an extreme position is in the interval 20°-60° (degrees measured on a sphere).

The orientation of the roller key is determined by measuring the impedance of a number of contact paths. These contact paths may be distributed on the interior surface of the housing so that the angle (measured in degrees around the housing) between a first and a second path and between the first and the third path is around 135°, while he angle between the second and the third path is around 90°. This last angle of 90° facilitates the use of the first and second impedance as a first and a second co-ordinate representing a position.

The device may further comprise means for sensing a pressure applied to the device—e.g. to the roller key. This sensing means may comprise at least two flexible conducting leg parts attached to the housing, so that the leg parts are brought into electrical contact upon applying the pressure to the roller key. Alternatively, the sensing means for sensing a pressure applied to the roller key may comprise a pin adapted to activate a switch mechanism upon applying the pressure to the roller key. The switch mechanism may be a small sized push-button or the like.

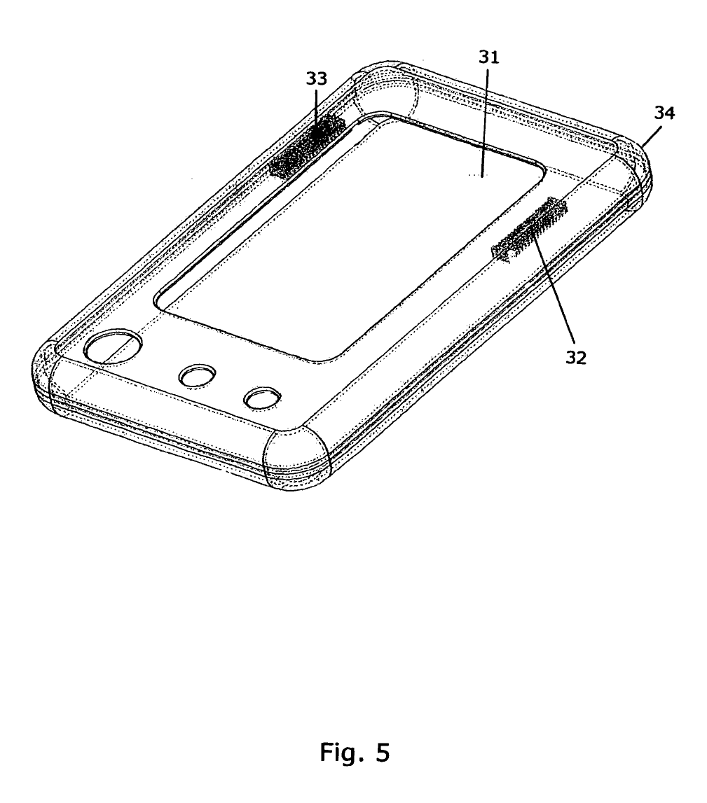

FIG. 5 shows a DPA 34 comprising a display and two loudspeakers 32,33 arranged in opposite sides of the display 31. It is evident that the above-mentioned characteristics for mobile phones also apply to DPA's, mobile game devices or the like.

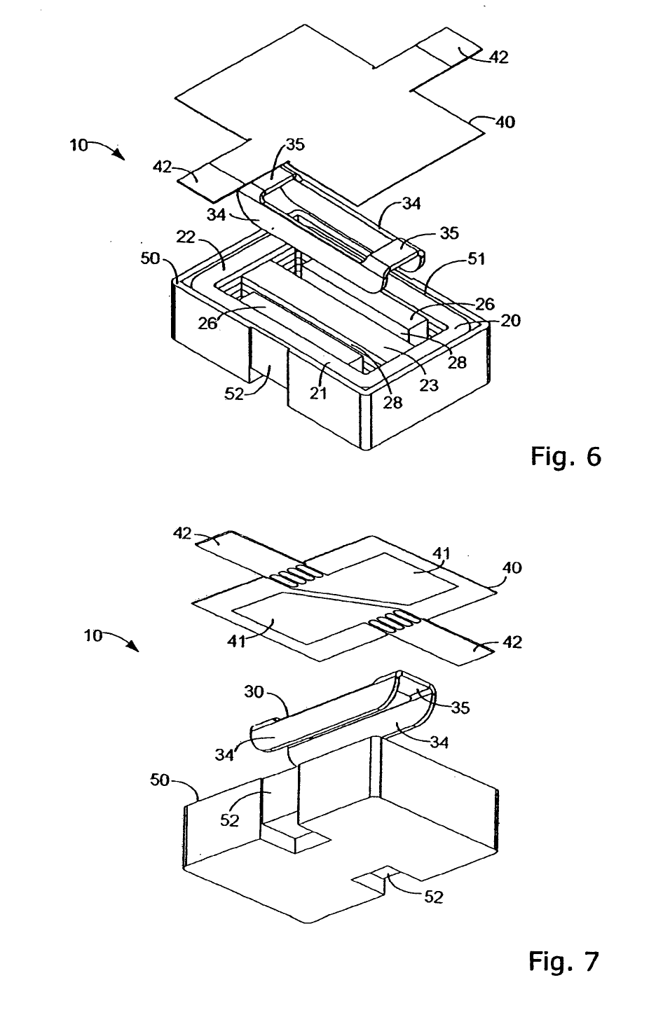

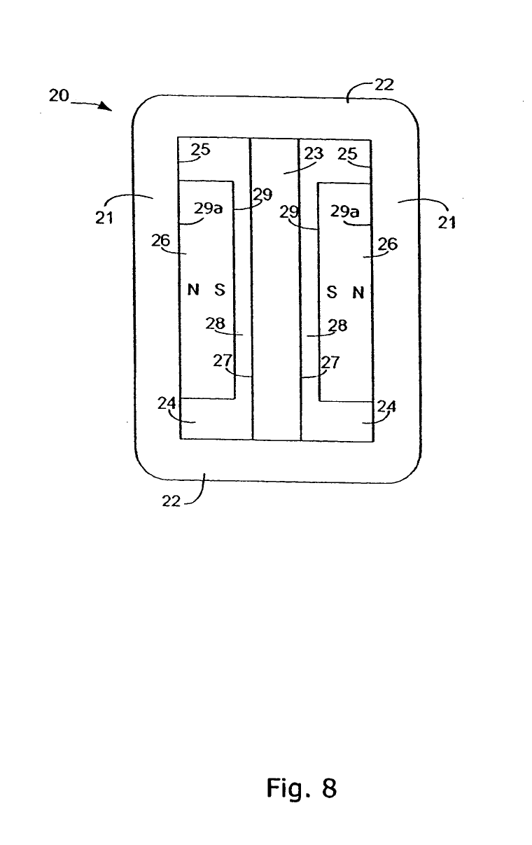

A main requirement for a loudspeaker to be suitable for being mounted as shown in FIGS. 1, 2 and 5 is that the loudspeaker is relatively thin. Furthermore, it should be very efficient. Preferably, such loudspeaker comprises—see FIGS. 6-8—a magnetic circuit 20 having two long legs 21 and two short legs 22 connected at their ends to form a ring of generally rectangular shape. A middle leg 23 interconnects the two short legs 22 dividing the internal of the rectangular ring into two rectangular openings 24. The two long legs 21, the two short legs 22 and the middle leg 23 of the magnetic circuit are of a magnetically soft material preferably having a high magnetic saturation value. The surfaces of the two long legs 21 and of the middle leg 23 facing towards the openings 24 are generally plane and define a gap therebetween. On the plane side 25 of each of the long legs 21 facing the opening 24 is a magnet 26 attached to the sides 25. The magnets 26 each have a magnetic pole surface attached to the long leg and the opposite free magnetic pole surface 29 facing the opening and the opposed plane surface 27 of the middle leg 23, whereby magnetic gaps 28 are defined between the free magnetic pole surfaces 29 and the surfaces 27 of the middle leg.

In an alternative embodiment (not shown), magnet 26 could be attached to the sides 27 of the middle leg 23. Thus, the magnets 26 each have a magnetic pole surface attached to the middle leg 23 and the opposite free magnetic pole surface 29a facing the opening and the opposed plane surface 25 of the long legs 21, whereby magnetic gaps, instead of being positioned between the middle leg 23 and the magnets 26, are defined between the free magnetic pole surfaces 29a and the surfaces 25 of the long legs.

Each magnet 26 creates a magnetic field in the corresponding gap 28, and the magnetic return paths are defined through the middle leg 23, the short legs 22 and the long legs 21. The magnetic return paths thus completely encircle the magnetic gaps 28 with the magnets each having a magnetic pole surface defining a gap 28. This gives a very flat and compact structure of the magnetic system with the magnetic field concentrated in the gaps 28 and a low stray magnetic field, which results in a high sensitivity and less need for magnetic shielding. The magnetic system 20 in FIG. 6 is situated in a plastic casing 50, e.g. by moulding or by fitting into a preformed “box”. The plastic casing may have a bottom closing the openings 24 or leave them open.

The coil of the loudspeaker may be formed by a thin and flexible sheet, such as a flexible printed circuit board, i.e. a flexprint. Such thin and flexible sheet will carry a predefined electrically conductive path thereon so as to form a coil-like electrical path. As explained later, the diaphragm will also in its preferred embodiment have electrically conductive portions. Therefore, the coil and diaphragm can be made from a single sheet of flexprint with appropriate conductive paths, and this sheet will be shaped in such a way that the two long sections of the coil will emerge and have an angle of 90 degrees with respect to the rest of the integrated diaphragm/coil structure.

The diaphragm is made from a thin and flexible sheet. On its lower side, the diaphragm 40 has electrically conductive portions 41, and the two short sections 35 of the coil are secured to the lower side of the diaphragm, e.g. by means of an adhesive, with the two wire ends 31 electrically connected to respective ones of the electrically conductive portions 41, e.g. by soldering or welding. The fact that the wire ends are connected directly to the diaphragm significantly reduces the risk of breaking/damaging the wires when the loudspeaker is operated, i.e. the diaphragm is moved, since the coil is secures to the diaphragm 40.

However, the wire ends may alternatively be electrically connected to terminals on the casing, e.g. by soldering.

The diaphragm 40 is rectangular in shape, and tongues 42 extend from the long sides of the diaphragm with the electrically conductive portions 41 extending to the tongues, so that the electrically conductive portions 41 on the tongues are electrically connected to respective ones of the coil wire ends 31.

The diaphragm 40 with the coil 30 thus secured thereto is then mounted on the magnetic system 20 with the two long sections 34 of the coil in respective ones of the gaps 28. The long sections 34 are therefore also referred to as gap portions of the coil. The two short sections 35 of the coil will be situated over the middle leg 23 and will bridge the two gap portions of the coil. The diaphragm will be secured to the magnetic system along its long edges. The diaphragm has a width corresponding to the distance between the inner sides of the edges 51 of the casing. If desired, the long edges of the diaphragm may be secured to the magnetic system by means of an adhesive. The short sides of the diaphragm are preferably free, whereby a narrow slot is provided giving access of air between the two sides of the diaphragm. The slot can be tuned to have desired acoustic properties influencing the acoustic performance of the loudspeaker, in particular at low frequencies.

If desired, the short edges of the diaphragm can also be secured to the magnetic system or to the casing, or, alternatively, the slot can be closed with a flexible substance so as to allow the short edges to move. However, the flexible substrate prevents air from going from one side of the diaphragm to the other.

In the preferred embodiment the diaphragm is rectangular, but other shapes can be used.

In FIG. 6 it is seen that the magnetic circuit is laminated from several layers, and that the uppermost layer the middle leg 23 the is omitted, so that the uppermost layer has the shape of the generally rectangular ring with two long legs and two short legs.

The “missing” part of the middle leg gives room for accommodating the bridging portions 35 of the coil. However, the “missing” is not imperative—other arrangements for generating the necessary room for the bridging portions 35 of the coil are available, such as providing indentations (typically two) in the middle leg 23.

The magnetic circuit may also be made as one solid block or as an outer ring with the middle leg inserted therein.

FIGS. 6 and 7 also show that, on its sides, the plastic casing 50 has two grooves or channels 52 ending on the bottom of the casing 50. The channels 52 have a width corresponding the width of the tongues 42. The tongues 42 will be bent and received in respective ones of the channels 52 with the ends of the tongues received in the part of the grooves at the bottom of the casing 50. The ends of the tongues will be bent 180 degrees so that the end of the conductive portion becomes exposed, or a through-plated hole will establish electrical connection through the tongue. The end portions of the conductive portions of the tongues will thus act as the electrical terminals of the loudspeaker.

Alternatively, the end portions of the conductive portions of the tongues can be soldered to electrical terminals mounted in the grooves 52 of the plastic housing 50.

The rectangular diaphragm is retained along two opposed edges, preferably the long edges and free at the two other edges. Hereby a simple bending motion of the diaphragm is obtained, and in comparison to loudspeakers having their diaphragm retained along the entire periphery the loudspeaker of the invention will have a relatively high sensitivity even with a relatively thick diaphragm.

In the preferred embodiment the magnetic circuit is rectangular, and there are two gaps receiving the gap portions of the coils, where the gaps are defined between opposed plane surfaces. In another configuration the magnetic circuit could have four gaps arranged like the sides of a square, and the coil would then correspondingly have four gap portions likewise arranged like the sides of a square. The bridging portions of the coil would then be at the corners of the square and be secured to the diaphragm at four locations. The outer contour of the magnetic circuit can have any desired shape including circular shape. Also, the gaps and the gap portions of the coils can be curved as arcs of a circle.

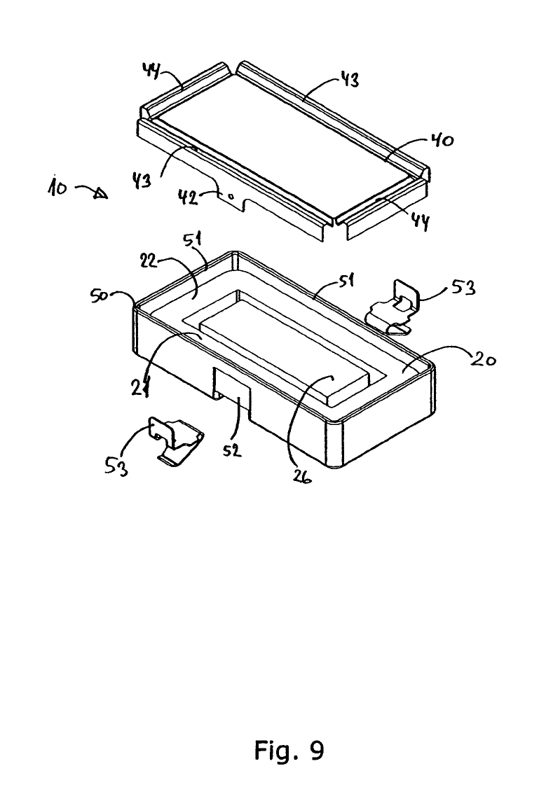

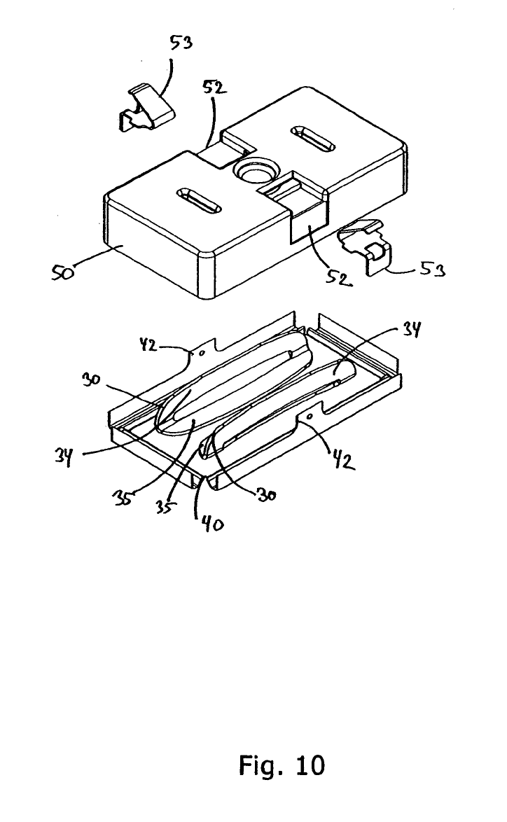

In a preferred embodiment the magnetic circuit is simplified in that the magnetic circuit comprises only a single magnet. FIGS. 9 and 10 show a transducer 10 according to the first aspect of the invention with its main components: a magnetic circuit 20, a coil system 30 and a diaphragm 40. FIG. 4 also shows the magnetic circuit 20.

As is best seen in FIG. 9, the magnetic circuit 20 has two long legs 21 and two short legs 22 connected at their ends to form a ring of generally rectangular shape, thus forming a rectangular through-going opening 24. The two long legs 21, the two short legs 22 are of a magnetically soft material preferably having a high magnetic saturation value. The surfaces 25 of the two long legs 21 facing towards the opening 24 are generally plane and define a gap there between. A magnet 26 is fixed in the centre of the opening in such a way that it is not in direct contact with the magnetically conductive material. The two poles of the magnet 26 are directed towards each of the long legs 21 thus defining gaps 28 between the magnetic pole surfaces 29 and the surfaces 25 of the long legs 21.

The rectangular magnet 26 creates a magnetic field in the gap 28, and the magnetic return paths are defined through the short legs 22 and the long legs 21. The magnetic return paths thus completely encircle the magnetic gaps 28 with the surfaces 29 of the magnet defining a gap 28. This gives a very flat and compact structure of the magnetic system with the magnetic field concentrated in the gaps 28 and a low stray magnetic field, which results in a high sensitivity and less need for magnetic shielding.

In FIGS. 9 and 10 the magnetic system 20 is situated in an e.g. plastic casing 50, e.g. by moulding or by fitting into a pre-formed “box”. The casing may have a bottom closing the openings 24 or leave them open. In the shown embodiment of the transducer 10, the coil system comprises two coils. Caused by the design of the magnetic system 20 the magnetic fields in the two gaps 28 have the same direction. Thus, the coil system should preferably be arranged so that the gap portions 34 in both gaps 28 will conduct electrical current in the same direction. In opposite case the electromagnetic forces would tend to tilt the membrane rather than tending to move in a linear motion, thus resulting in poor sensitivity and distortion.

In yet another alternative embodiment of the coil system 30, a coil 30 may be formed by a thin and flexible sheet, such as a flexible printed circuit board, i.e. a flexprint. Such thin and flexible sheet will carry a predefined electrically conductive path thereon so as to form a coil-like electrical path. As explained later, the diaphragm 40 will also in its preferred embodiment have electrically conductive portions. Therefore, the coil 30 and diaphragm 40 can be made from a single sheet of flexprint with appropriate conductive paths, and this sheet will be shaped in such a way that the two long sections of the coil 30 will emerge and have an angle of 90 degrees with respect to the rest of the integrated diaphragm 40/coil 30 structure. The flexprint can either be single or double sided. The coil structure can either be formed using etching technique or it can be formed using laser technique.

In order to increase the filling portion of coil material in the magnetic gap 28, the coil paths can be made quite wide. This will increase the sensitivity of the transducer 10 traded for a low impedance of the transducer 10. In case the impedance is too low to operate with traditional electronic amplifier equipment used for instance within mobile phones, an impedance converter contained in a chip 70 can be mounted on the diaphragm 40.

In an alternative embodiment—see FIG. 11—the loudspeaker may be a dual diaphragm configuration having the following main components: a magnetic circuit 10, a first coil 2, a second coil 12, a first diaphragm 1, a second diaphragm 13, and four terminals 6-9. The magnetic circuit 10 may comprise one or more magnets. For simplicity, the following description of a dual diaphragm configuration will be given with reference to a two-magnet magnetic circuit 10. However, this should not be regarded as a limitation of the present invention in terms of implementation the magnetic circuit 10.

As seen in FIG. 11, the dual loudspeaker configuration comprises two diaphragms 1,13 and two coils 2,12 having a common magnetic circuit. The two diaphragms may be driven in two modes of operation—either with the same polarity or in opposite polarity. In case the two diaphragms are driven in the same direction in response to an incoming electric signal, the loudspeaker is driven in a so-called vibration mode. Vibration mode leads to maximum vibration but no sound output. In case the two diaphragms are driven in opposite directions maximum sound output is provided, and the loudspeaker is vibration-free. Terminals 6 and 8 provide electrical contact to coil 2, whereas terminals 7 and 9 provide electrical contact to coil 12. The contact between the terminal and the coils may be provided via conducting portions of the diaphragms 25,26.

The dual loudspeaker is especially suitable for applications where the space available for the loudspeaker is very limited. By using the dual configuration a much better ratio between efficiency versus, volume and maximum output versus volume may be achieved.

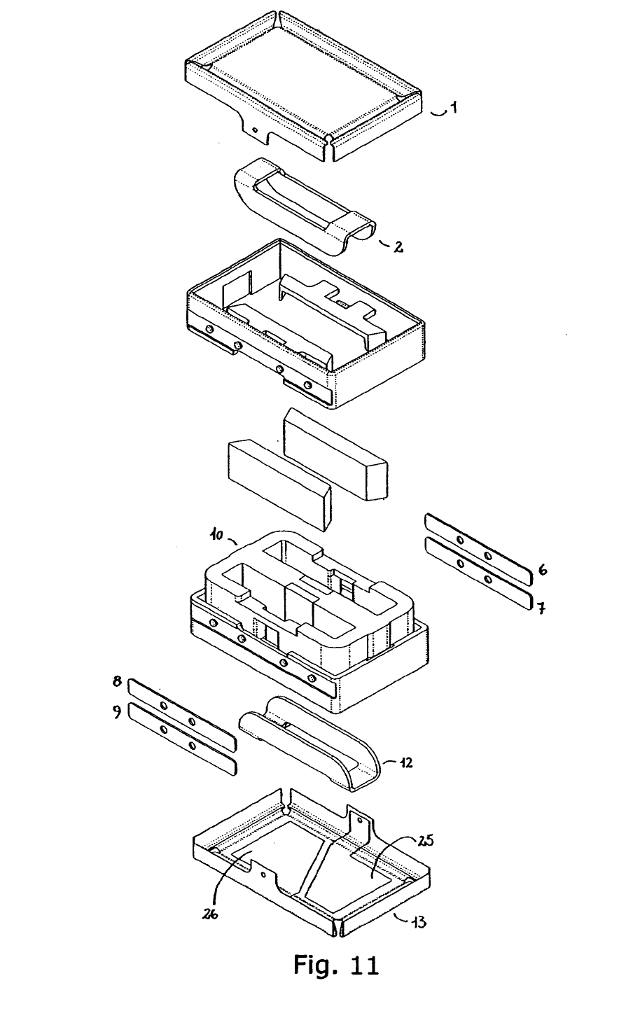

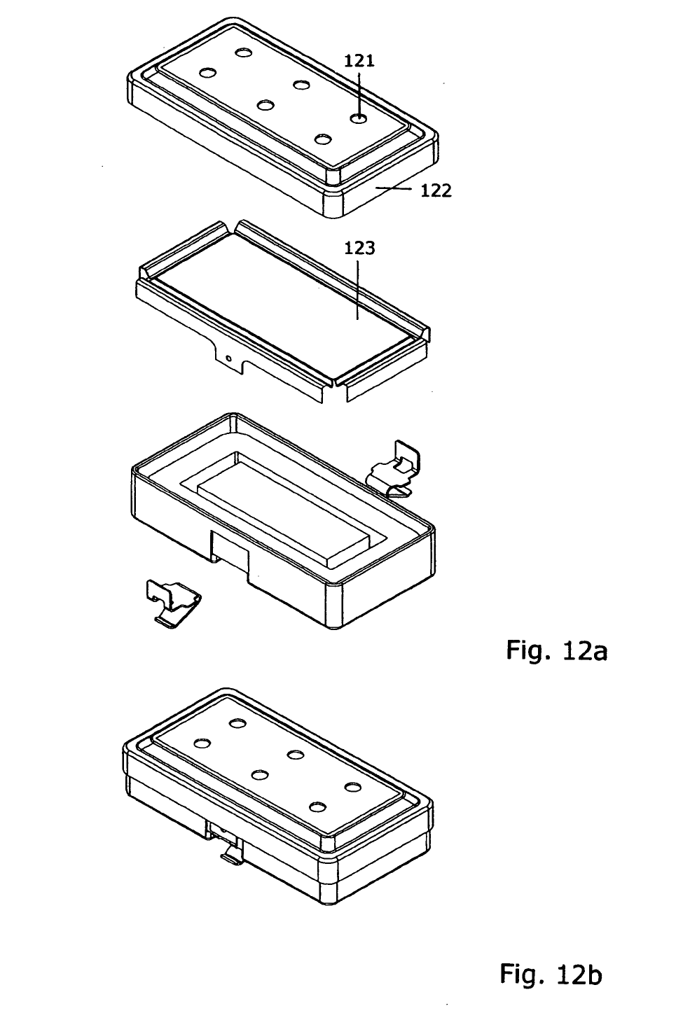

FIG. 12 shows a loudspeaker with a conventional front cover 122 for transmitting sound in a primary direction being substantially parallel to the movements of the diaphragm 123. The sound is transmitted through holes 121. The sound transmitting holes may in principle take any form.

FIG. 13 shows a loudspeaker with a non-conventional (side-shooting) front cover 132 in that sound is primarily intended to be transmitted in a direction being substantially perpendicular to the movements of the diaphragm 133. The sound is transmitted through holes 131 which in principle may take any form.

Providing a satisfactory stereo perspective using two loudspeakers positioned very close is problematic. Even when held quite close to the listener's face the small dimensions of mobile equipment makes it difficult to obtain enough distance between the stereo speakers in order to obtain a wide stereo perspective. Providing a stereo signal intended to be reproduced by a normal stereo set-up will result in a poor stereo effect—this mainly being a result of so-called cross talk—the fact that the signal from left loudspeaker is heard not only by the left ear but also by the right ear. The closer the two loudspeakers are positioned, the more pronounced this cross talk effect will be.

One possible way of solving this problem would be to use directional loudspeaker units. The left loudspeaker should then be directed to radiate sound primarily towards the left ear, whereas the right loudspeaker should be directed to radiate sound primarily towards the right ear, when the near-to-the-eye handset is held in a normal position in from of the user's eye.

The above-mentioned loudspeaker units having long and slim diaphragms, thus forming an acoustical line source, are directional perpendicular to their axis, however substantially omnidirectional around their axis. This is an essential feature in order to be able to direct sound towards the listener and not towards the surroundings. However, it does not solve the problem with the loudspeaker units being very close together, since in the left-right direction the loudspeaker units are substantially omnidirectional.

However, the stereo performance can be electronically increased by using different types of manipulation of the signals provided to the left and right loudspeaker. Such effects are known from portable radio receivers and “ghetto blasters”. An example of such manipulation for obtaining an enhanced stereo effect is to add, in a limited frequency range, the difference signal between left and right channel. This normally provides a “spatial” effect.

However, a more complicated way of improving the stereo effect is an electronical cross talk cancellation system, such as known from the literature. Taking into account the sound transfer path from each loudspeaker to each ear and provide an electronical cancellation (suppression) of the left to right and right to left cross talk paths. The individual sound transmission paths can be measured from each of the loudspeakers to the ears of a human test subject.

With the near-to-the-eye handset rather close to the user's one eye, the acoustical shadow effect of the user's head will be quite pronounced, thus, helping to introduce a certain difference, which will assist such system to work. Since the handset is used in front of one eye the setup is even asymmetrical. However, this may also be compensated in the signal processing. The system may be implemented so as to allow switching between a left-eye and a right-eye mode of operation. The near-to-the-eye mobile handset is suitable for application of a cross cancellation system to function properly due to a large distance to the nearest acoustically reflective surface in the surroundings and due to the quite fixed position of the near-to-the-eye handset when it is used. With a cross cancellation system implemented it is substantially possible to provide the desired sound to left and right ear of the user. Therefore, it is in principle possible to provide any desired spatial sound impression including 3D reproduction by using binaural signals—either recorded using a dummy head or computer synthesised.

Another alternative with near-to-the-eye displays is to reproduce stereo sound by means of headphones. With headphones it is possible to reproduce stereo and even true 3D sound and at the same time preserve privacy, since it is not possible for persons near by to hear the sound from the headphone. However, headphones have a number of disadvantages. They are often uncomfortable, they increase the total dimensions and weight of the mobile system, and it is more time consuming finding, plugging in and putting on headphones compared to using the built-in loudspeakers of the mobile handset.

1. A mobile handset comprising
a handset housing comprising a front and a back cover,
display means being visible from the front cover side of the handset housing, the display means being adapted to provide visual information to a user of the mobile handset, and
a plurality of loudspeakers being adapted to generate audio signals, wherein each of the plurality of loudspeakers comprises a magnetic circuit comprising a magnet, the magnetic circuit having at least one gap defined between two opposed and substantially parallel surfaces of the magnetic circuit, the magnet of the magnetic circuit causes a magnetic field to exist across the at least one gap,
wherein the magnetic circuit defines magnetic return paths completely encircling the gap.

2. A mobile handset according to claim 1, further comprising image compensation means so as to allow the mobile handset to be applied in near-to-the-eye applications.

3. A mobile handset according to claim 1, wherein the display means is a colour display, such as a LCOS display.

4. A mobile handset according to claim 1, wherein the plurality of loudspeakers are arranged within the handset housing so that the audio signals are transmitted from the front cover of the handset housing.

5. A mobile handset according to claim 4, wherein the plurality of loudspeakers comprise loudspeaker front covers each having at least one acoustic opening arranged so that the audio signals are transmitted primarily in a direction being perpendicular to a mean plane defined by the loudspeaker front cover.

6. A mobile handset according to claim 1, wherein the plurality of loudspeakers are arranged within the handset housing so that the audio signals are transmitted from a side of the handset housing.

7. A mobile handset according to claim 6, wherein the plurality of loudspeakers comprise loudspeaker front covers each having at least one acoustic opening arranged so that the audio signals are transmitted primarily in a direction being parallel to a mean plane defined by the loudspeaker front cover.

8. A mobile handset according to claim 1, wherein two loudspeakers are arranged at two opposing sides of the display means.

9. A mobile handset according to claim 8, wherein a third speaker is positioned between the two oppositely arranged loudspeakers and at a third side of the display means.

10. A mobile handset according to claim 1, wherein each of the plurality of loudspeakers comprises a number of loudspeaker units, each loudspeaker unit comprising at least one movable diaphragm.

11. A mobile handset according to claim 1, further comprising means for controlling a pointer shown on the display means.

12. A mobile handset according to claim 11, wherein the control means comprises a navigation key accessible from the back cover side of the handset housing, the navigation key being capable of providing two-dimensional control of the pointer shown on the display means.

13. A mobile handset according to claim 12, wherein the navigation key is capable of selecting information displayed on the display means upon moving the navigation key from an initial position to a select position.

14. A mobile handset according to claim 13, wherein the navigation key is moved from the initial position to the select position by applying a pressure to the navigation key in a direction towards the back cover of the handset housing.

15. A mobile handset according to claim 1, further comprising vibration means so as to mechanically vibrate the mobile handset in accordance with a vibration signal provided to the vibration means.

16. A mobile handset according to claim 1, further comprising a number of drivers for driving the loudspeaker.

17. A mobile handset according to claim 16, wherein the number of driver comprises a number of class D drivers.

18. A mobile handset according to claim 16, further comprising an electronic decoding circuit for decoding a received digital signal into two or more driver signals, each driver signal being provided to a loudspeaker via at least one driver.

19. A mobile handset according to claim 1, further comprising means for enhancing the stereo reproduction.

20. A mobile handset according to claim 19, wherein the means for enhancing the stereo reproduction comprises cross talk cancellation.

21. A mobile handset according to any claim 1, wherein the mobile handset is a mobile phone, a PDA, or a portable game device.

22. A mobile handset comprising
a handset housing comprising a front and a back cover,
a plurality of loudspeakers being adapted to generate audio signals,
display means being visible from the front cover side of the handset housing, the display means being adapted to provide visual information to a user of the mobile handset, and
image compensation means so as to allow the mobile handset to be applied in near-to-the-eye applications.

23. A mobile handset according to claim 22, wherein each of the plurality of loudspeakers comprises a magnetic circuit comprising a magnet, the magnetic circuit having at least one gap defined between two opposed and substantially parallel surfaces of the magnetic circuit, the magnet of the magnetic circuit causes a magnetic field to exist across the at least one gap, and wherein the magnetic circuit defines magnetic return paths completely encircling the gap.

24. A mobile handset according to claim 22, wherein the display means is a colour display, such as a LCOS display.

25. A mobile handset according to claim 22, wherein the plurality of loudspeakers are arranged within the handset housing so that the audio signals are transmitted from the front cover of the handset housing.

26. A mobile handset according to claim 25, wherein the plurality of loudspeakers comprise loudspeaker front covers each having at least one acoustic opening arranged so that the audio signals are transmitted primarily in a direction being perpendicular to a mean plane defined by the loudspeaker front cover.

27. A mobile handset according to claim 22, wherein the plurality of loudspeakers are arranged within the handset housing so that the audio signals are transmitted from a side of the handset housing.

28. A mobile handset according to claim 27, wherein the plurality of loudspeakers comprise loudspeaker front covers each having at least one acoustic opening arranged so that the audio signals are transmitted primarily in a direction being parallel to a mean plane defined by the loudspeaker front cover.

29. A mobile handset according to claim 28, wherein two loudspeakers are arranged at two opposing sides of the display means.

30. A mobile handset according to claim 29, wherein a third speaker is positioned between the two oppositely arranged loudspeakers and at a third side of the display means.

31. A mobile handset according to claim 22, wherein each of the plurality of loudspeakers comprises a number of loudspeaker units, each loudspeaker unit comprising at least one movable diaphragm.

32. A mobile handset according to claim 22, further comprising means for controlling a pointer shown on the display means.

33. A mobile handset according to claim 32, wherein the control means comprises a navigation key accessible from the back cover side of the handset housing, the navigation key being capable of providing two-dimensional control of the pointer shown on the display means.

34. A mobile handset according to claim 33, wherein the navigation key is capable of selecting information displayed on the display means upon moving the navigation key from an initial position to a select position.

35. A mobile handset according to claim 34, wherein the navigation key is moved from the initial position to the select position by applying a pressure to the navigation key in a direction towards the back cover of the handset housing.

36. A mobile handset according to claim 22, further comprising vibration means so as to mechanically vibrate the mobile handset in accordance with a vibration signal provided to the vibration means.

37. A mobile handset according to claim 22, further comprising a number of drivers for driving the loudspeaker.

38. A mobile handset according to claim 37, wherein the number of driver comprises a number of class D drivers.

39. A mobile handset according to claim 37, further comprising an electronic decoding circuit for decoding a received digital signal into two or more driver signals, each driver signal being provided to a loudspeaker via at least one driver.

40. A mobile handset according to claim 22, further comprising means for enhancing the stereo reproduction.

41. A mobile handset according to claim 40, wherein the means for enhancing the stereo reproduction comprises cross talk cancellation.

42. A mobile handset according to claim 22, wherein the mobile handset is a mobile phone, a PDA, or a portable game device.

43. A display and audio assembly for mobile handsets, the display and audio assembly comprising
display means adapted to provide visual information,
a plurality of loudspeakers being adapted to generate audio signals, wherein each of the plurality of loudspeakers comprises a magnetic circuit comprising a magnet, the magnetic circuit having at least one gap defined between two opposed and substantially parallel surfaces of the magnetic circuit, the magnet of the magnetic circuit causes a magnetic field to exist across the at least one gap,
wherein the magnetic circuit defines magnetic return paths completely encircling the gap.

44. An assembly according to claim 43, further comprising image compensation means so as to allow the assembly to be applied in near-to-the-eye applications.

45. An assembly according to claim 43, wherein the display means is a colour display, such as a LCOS display.

46. An assembly according to claim 43, wherein two loudspeakers are arranged at two opposing sides of the display means.

47. An assembly according to claim 46, wherein a third speaker is positioned between the two oppositely arranged loudspeakers and at a third side of the display means.

48. An assembly according to claim 43, wherein each of the plurality of loudspeakers comprises a number of loudspeaker units, each loudspeaker unit comprising at least one movable diaphragm.

49. An assembly according to claim 43, further comprising means for controlling a pointer shown on the display means.

50. An assembly according to claim 49, wherein the control means comprises a navigation key, the navigation key being capable of providing two-dimensional control of the pointer shown on the display means.

51. An assembly according to claim 50, wherein the navigation key is capable of selecting information displayed on the display means upon moving the navigation key from an initial position to a select position.

52. An assembly according to claim 43, further comprising a number of drivers for driving the loudspeaker.

53. An assembly according to claim 52, wherein the number of driver comprises a number of class D drivers.

54. An assembly according to claim 52, further comprising an electronic decoding circuit for decoding a received digital signal into two or more driver signals, each driver signal being provided to a loudspeaker via at least one driver.

55. A display and audio assembly for mobile handsets, the display and audio assembly comprising
display means adapted to provide visual information,
image compensation means so as to allow the display and audio assembly to be applied in near-to-the-eye applications, and
a plurality of loudspeakers being adapted to generate audio signals.

56. A display and audio assembly according to claim 55, wherein each of the plurality of loudspeakers comprises a magnetic circuit comprising a magnet, the magnetic circuit having at least one gap defined between two opposed and substantially parallel surfaces of the magnetic circuit, the magnet of the magnetic circuit causes a magnetic field to exist across the at least one gap, and wherein the magnetic circuit defines magnetic return paths completely encircling the gap.

57. An assembly according to claim 55, wherein the display means is a colour display, such as a LCOS display.

58. An assembly according to claim 55, wherein two loudspeakers are arranged at two opposing sides of the display means.

59. An assembly according to claim 58, wherein a third speaker is positioned between the two oppositely arranged loudspeakers and at a third side of the display means.

60. An assembly according to claim 55, wherein each of the plurality of loudspeakers comprises a number of loudspeaker units, each loudspeaker unit comprising at least one movable diaphragm.

61. An assembly according to claim 55, further comprising means for controlling a pointer shown on the display means.

62. An assembly according to claim 61, wherein the control means comprises a navigation key, the navigation key being capable of providing two-dimensional control of the pointer shown on the display means.

63. An assembly according to claim 62, wherein the navigation key is capable of selecting information displayed on the display means upon moving the navigation key from an initial position to a select position.

64. An assembly according to claim 55, further comprising a number of drivers for driving the loudspeaker.

65. An assembly according to claim 64, wherein the number of driver comprises a number of class D drivers.

66. An assembly according to claim 64, further comprising an electronic decoding circuit for decoding a received digital signal into two or more driver signals, each driver signal being provided to a loudspeaker via at least one driver.
